(19) United States
(12) Patent Application Publication
(10) Pub. No.: US 2020/0406212 A1
(43) Pub. Date: Dec. 31, 2020

(54) SYSTEM AND PROCESS FOR SYNTHESIS GAS PRODUCTION

(71) Applicant: HALDOR TOPSØE A/S, Kgs. Lyngby (DK)

(72) Inventors: Peter Mølgaard MORTENSEN, Roskilde (DK); Kim AASBERG-PETERSEN, Allerød (DK)

(73) Assignee: HALDOR TOPSØE A/S, Kgs. Lyngby (DK)

(21) Appl. No.: 16/767,302

(22) PCT Filed: Nov. 15, 2018
(86) PCT No.: PCT/EP2018/081405

§ 371 Date: May 27, 2020

(30) Foreign Application Priority Data
Dec. 8, 2017 (DK) PA 2017 00698

(51) Int. Cl. B01J 8/06; B01J 19/12; B01J 19/24; B01J 8/02; B01J 8/04; C01B 3/38

(52) U.S. Cl. CPC B01J 8/067; B01J 19/12; B01J 19/244; B01J 8/025; B01J 8/0465; C01B 2203/1241; B01J 2208/00433; C01B 2203/0233; C01B 2203/0283; C01B 2203/0855; C01B 3/384

(57) ABSTRACT

The invention relates to a chemical reactor comprising reformer tubes for reforming a first feed stream comprising a hydrocarbon gas and steam. The chemical reactor comprises one or more reformer tubes arranged to being heated by an electrically driven heat source. The reformer tube comprises a first inlet for feeding said first feed stream into a first reforming reaction zone of the reformer tube, and a feed conduit arranged to allow a second feed stream into a second reforming reaction zone of the reformer tube. The second reforming reaction zone is positioned downstream of the first reforming reaction zone. The feed conduit is configured so that the second feed stream is only in contact with catalyst material in the second reforming reaction zone. The invention also relates to a process of producing CO rich synthesis gas at low S/C conditions.

### FIELD OF THE INVENTION

Embodiments of the invention generally relate to a chemical reactor for reforming of a first feed stream comprising a hydrocarbon gas and steam, and a reformer tube of such a chemical reactor. Other embodiments of the invention relate to a process of reforming a first feed stream comprising a hydrocarbon gas and steam in a chemical reactor and a plant for reforming a first feed stream comprising a hydrocarbon gas and steam. In particular, the invention relates to a reforming process aimed at producing a synthesis gas stream with a low H₂/CO ratio.

### BACKGROUND

Catalytic synthesis gas production by steam reforming of a hydrocarbon feed stream has been known for decades. The endothermic steam reforming reaction is typically carried out in a steam reformer (SMR). A steam reformer or steam methane reformer has a number of catalyst filled tubes placed in a furnace or fired heater to provide the heat for the endothermic reaction. The tubes are normally 10-14 meters in length and 7-15 cm in inner diameter. The heat for the endothermic reaction is supplied by combustion of fuels in burners in the furnace. The synthesis gas exit temperature from the steam reformer depends on the application of the synthesis gas but will normally be in the range from 650° C.-980° C.

It is also known that carbon formation on the catalyst used in catalytic synthesis gas production by steam reforming is a challenge, especially for production of synthesis gasses with a relatively low H₂/CO ratio. Therefore, catalysts resistant to carbon formation are required for such synthesis gasses. Such carbon resistant catalysts are e.g. noble metal catalysts, partly passivated nickel catalysts, and promoted nickel catalysts. Moreover, industrial scale reforming of CO₂ rich gas typically requires a co-feed of water to decrease the severity of the gas for carbon formation. From a thermodynamic viewpoint, it is advantageous to have a high concentration of CO₂ and a low concentration of steam in the feed to promote the production of synthesis gas with a low H₂/CO ratio. However, operation at such conditions may not be feasible due to the possibility of carbon formation on the catalyst.

Alternative production of a synthesis gas with a low H₂/CO ratio by steam reforming is a sulfur passivated reforming (SPARG) process which may be used for producing synthesis gas with a relatively low H₂/CO ratio. This process requires desulfurization of the produced synthesis gas to produce a sulphur free synthesis gas.

More details of various processes for producing synthesis gas with low H₂/CO-ratio can be found in “Industrial scale experience on steam reforming of CO₂-rich gas”, P. M. Mortensen & I. Dybkjr, Applied Catalysis A: General, 495 (2015), 141-151.

Within this context, the terms “reforming” and “methane reforming” are meant to denote reforming according to one or more of the following reactions:

CH₄+H₂O↔CO+3H₂ (i)

CH₄+2H₂O↔CO₂+4H₂ (ii)

CH₄+CO₂↔2CO+2H₂ (iii)

For higher hydrocarbons, viz. CₙHₘ, where n≥2, m≥4, equation (i) is generalized as:

CₙHₘ+nH₂O→nCO+(n+m/2)H₂ (iv), where n≥2, m≥4

Typically, reforming is accompanied by the water gas shift reaction (v):

CO+H₂O↔CO₂+H₂ (v)

The term “steam methane reforming” is meant to cover the reactions (i) and (ii), running from the left towards the right side of the arrow, whilst the term “methanation” is meant to cover the reactions (i) and/or (ii) running from the right towards the left side of the arrow. Thus, the term “steam methane reforming/methanation reactions” is meant to denote the reactions (i) and (ii) running towards equilibrium. The term “reverse water gas shift” is meant to denote the reaction (v), running from the right towards the left side of the arrow, whilst reaction (iii), running from the left towards the right side of the arrow, is the dry methane reforming reaction. In most cases, all of these reactions are at, or close to, equilibrium at the outlet from the catalyst bed or catalyst zone of the reactor concerned.

### SUMMARY OF THE INVENTION

In the following, reference is made to embodiments of the invention. However, it should be understood that the invention is not limited to specific described embodiments. Instead, any combination of the following features and elements, whether related to different embodiments or not, is contemplated to implement and practice the invention.

Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments, and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments of the invention generally relate to reforming of a hydrocarbon feed stream in reforming reaction zones within the tubes of a reforming reactor. The term “reforming reaction zone” is meant to denote a catalytic zone of the reactor, where the steam methane reforming reaction (reactions (i), (ii) and optionally (iv)) takes place. Typically, dry methane reforming reaction (reaction (iii)), and water gas shift reactions (reaction (v)) also take place in the reforming reaction zone.

One embodiment of the invention provides a chemical reactor for reforming of a first feed stream comprising a hydrocarbon gas and steam. The chemical reactor comprises a reformer tube arranged to house catalyst material. The reformer tube comprises a first inlet for feeding the first feed stream into a first reforming reaction zone of the reformer tube, and a feed conduit arranged to conduct a second feed stream in heat exchange contact with the catalyst material housed within the reformer tube and to allow the second feed stream into a second reforming reaction zone of the reformer tube, where the second reforming reaction zone is positioned downstream of the first reforming reaction zone, and wherein the feed conduit is configured so that the second feed stream is in contact with catalyst material in the second reforming reaction zone only. The chemical reactor also comprises an electrically driven heat source arranged to heat the catalyst material within the reformer tube.

Hereby, it is rendered possible to add the second feed stream into the chemical reactor at a position where the first feed stream has already been at least partly reformed. Typically, the catalyst material within the reformer tube is a reforming catalyst material. Typically, the first and the second reforming reaction zones contain the same type of catalyst material. The catalyst material is advantageously a catalyst material arranged for catalyzing the steam methane reforming reaction (reactions (i), (ii) and optionally reaction (iv)). Preferably, the catalyst material is suitable for catalyzing both the steam methane reforming (reactions (i), (ii) and optionally reaction (iv)), the dry methane reforming (reaction (iii)) and the water gas shift reactions (reaction (v)). The terms “catalyst” and “catalyst material” are used interchangeably herein.

The chemical reactor of the invention generates a product gas in the form of a CO rich synthesis gas. The chemical reactor of the invention is preferably a steam reformer or steam methane reformer.

The term “hydrocarbon gas” is meant to denote a gas stream comprising one or more hydrocarbon gasses, and possibly other gasses. Examples of “a hydrocarbon gas” may be natural gas, town gas, or a mixture of methane and higher hydrocarbons.

Typically, the hydrocarbon gas stream comprises minor amounts of hydrogen, carbon monoxide, carbon dioxide, nitrogen, or argon, or combinations thereof. Thus, the “first feed stream comprising a hydrocarbon gas and steam” typically comprises one or more hydrocarbons, minor amounts of hydrogen, carbon monoxide, carbon dioxide, nitrogen, or argon, or combinations thereof, in addition to the steam and possibly carbon dioxide added to the hydrocarbon gas. For reforming processes, an example of a “first feed stream comprising a hydrocarbon gas and steam” is e.g. a mixture of methane, steam, and possibly other oxidizing gasses, such as carbon dioxide. Examples of “a hydrocarbon gas” may be natural gas, town gas, or a mixture of methane and higher hydrocarbons. The term “second feed stream” is meant to denote another stream different from the “first feed stream”. Thus, the second feed stream may be any appropriate gas stream suitable for supporting the reforming reaction within a reforming reactor and/or for assisting the provision of a CO rich synthesis gas, typically CO₂ rich gasses comprising at least 50% dry mole CO₂, such as at least 70 dry mole %, such as at least 90 dry mole %. The term “downstream” as used in this text is meant to denote at “a later point or position in a process or system”, whilst the term “upstream” is meant to denote “at an earlier point or position in a process or system”. In a case where the term “downstream” or “upstream” is used in relation to the reformer tube, which may conduct both a first and a second feed stream, these terms are meant to be in relation to the flow direction of first feed stream, unless otherwise specified.

Within this context, the term “CO rich product gas” is meant to be synonymous to “CO rich synthesis gas” and to “synthesis gas stream with a low H₂/CO ratio”, such as a synthesis gas with a H₂/CO ratio below 2.5, preferably a synthesis gas with a H₂/CO ratio below 2.0, more preferably a synthesis gas with a H₂/CO ratio below 1.8, even more preferably a synthesis gas with a H₂/CO ratio below 1.6

The term “first reforming reaction zone” is meant to denote the part of the catalyst housing reformer tube extending from the first inlet to the second reforming reaction zone, downstream of the first reforming reaction zone. The term “second reforming reaction zone” is meant to denote the part of the catalyst housing reformer tube from the point of inletting the second feed stream into the reformer tube. This point is here denoted “an addition point” or “an addition zone” in the case where the second feed stream is added at more than one point of the flow direction of the first feed stream along the chemical reactor. The chemical reactor may be designed so that the first and second feed streams flow cocurrently or counter-currently through the chemical reactor. In the case, where the first and second feed streams flow counter-currently, terms such as “downstream of the first reforming reaction zone” and “upstream the second reforming reaction zone” is as seen from the flow direction of the first feed stream.

The second reforming reaction zone thus comprises an addition point or an addition zone at/along which the second feed stream is inlet from the feed conduit into the catalyst housing reformer tube. The addition point may be longitudinal in the case where a number of inlets from the feed conduit into the reformer tube exists or in the case where a frit material extending along at least a part of the longitudinal axis of the reformer tube is arranged to inlet the second feed stream into the addition zone. When the addition zone has a relatively short longitudinal extent, e.g. if the additional zone is at a point only along the longitudinal axis of the reformer tube, it is denoted “addition point”. Optionally, the second reforming section also comprises catalyst housing zone downstream (as seen from the first feed stream) the addition point/addition zone, in which no further second feed stream (or other feed stream) is added. This is denoted a third reforming reaction zone. Alternatively, the addition zone extends along all of the second reforming reaction zone. In this case, no third reforming reaction zone exists.

The term “the second feed stream is in contact with catalyst material in the second reforming reaction zone only” is meant to denote, that the second feed stream is inlet into the catalyst housing part of reformer tube at the addition point or the most upstream part of the addition zone. Even though the second feed stream has heat exchange contact with the first reforming reaction zone through the wall(s) of the feed conduit, there is not fluid or physical contact between the second feed stream and the catalyst material until the second feed stream has entered into the second reforming reaction zone. Thus, the second feed stream is not in fluid contact or physical contact with catalyst material within the first reforming reaction zone.

The feed conduit is configured so that the second feed stream is kept separate from the first feed stream, so that the second feed stream does not contact the catalyst material within the reformer tube until the second feed stream reaches the second reforming reaction zone. Typically, the first feed stream and the second feed stream are streams of different compositions.

In summary, the catalyst housing part of the reformer tube contains a first and a second reforming reaction zone, where the second reforming reaction zone is downstream the first reforming reaction zone. The second reforming reaction zone has an addition zone or addition point, where the second feed stream is inlet into reformer tube, reaching the catalyst material and being mixed with a partly reformed first feed stream. The second reforming reaction zone may comprise a third reforming reaction zone downstream the addition point/addition zone. No further stream is added in the third reforming reaction zone. Each of the reforming reaction zones comprises catalyst material arranged to catalyze a reforming reaction. The feed conduit typically does not comprise any catalyst. As seen along the direction of the first gas stream along the reformer tube, the first reforming reaction zone is the most upstream zone of the first and second reforming reaction zones. Within the second reforming reaction zone, the addition point or addition zone is meant to denote the most upstream part followed by the optional third reforming reaction zone. Typically, the first reforming reaction zone extends from the inlet of the first feed stream or from the most upstream part of the catalyst material within the reformer tube, and the second reforming reaction zone extends from the first reforming reaction zone to an outlet for outletting a first synthesis gas from the reformer tube, or to the most downstream part (as seen from the first feed stream) of the catalyst material within the reformer tube.

It should be understood that the term “an inlet” and “an outlet” is not intended to be limiting. Thus, these terms also cover the possibility where the units, e.g. the reformer tube, have more than one inlet and/or outlet. For example, a reformer tube could have an inlet for hydrocarbon gas and another inlet for steam, so that the hydrocarbon gas and steam is mixed within the reformer tube.

The term “electrically driven heat source” is meant to denote a heat source that is powered by an electrical power source and thereupon provides heating. In the invention, the electrically driven heat source of the chemical reactor may be solely electrically driven, so that no other heat sources are present; alternatively, other heat sources, such as e.g. a convective heat exchanger, may be used in addition to the electrically driven heat source.

The term “catalyst housing reactor tube” is meant to indicate that the chemical reactor tube houses catalyst material. The reactor tube may also house other material, such as electrically conductive and/or ferromagnetic elements.

Typically, the first feed stream/the hydrocarbon gas will have undergone desulfurization to remove any sulfur in the gas and thereby avoid deactivation of the catalysts in the process.

Optionally, the first feed stream/the hydrocarbon gas will together with steam have undergone adiabatic prereforming according to reaction (iv) in a temperature range of ca. 350-550° C. to convert higher hydrocarbons as initial steps in the process normally taking place downstream the desulfurization step. This removes the risk of carbon formation from higher hydrocarbons on catalyst in the subsequent process steps.

In an embodiment, the feed conduit comprises a first part arranged for conducting the second feed stream in heat exchange contact with catalyst material housed within the reformer tube, and a second part arranged for inletting the second feed stream into the second reforming reaction zone of the reformer tube. Typically, the second feed stream within the feed conduit is heated by heat exchange between the feed conduit and the first reforming reaction zone upstream the second reforming reaction zone, prior to being inlet into the second reforming reaction zone. Alternatively, the second feed stream may be led along the second reforming reaction zone, in heat exchange contact with the catalyst material therein, i.e. in countercurrent to the stream in the second reforming reaction zone and in the third reforming reaction zone. The second part of the feed conduit may be relatively small, for example in case of only inlets into one point along the longitudinal axis of the reformer tube, or the second part of the feed conduit may be elongate in case of inlets at more than one point along the longitudinal axis of the reformer tube.

In an embodiment, the feed conduit extends into the second reforming reaction zone and the feed conduit comprises a baffle arranged to conduct the second feed stream in heat exchange contact with the second reforming reaction zone prior to allowing the second feed stream into the second reforming reaction zone via the second part. This provides for an increased heat exchange area between the second feed stream and catalyst material within the reformer tube, and thus to an increased heat flux.

In an embodiment, the feed conduit extends within the reformer tube from a first and/or a second end of the reformer tube to the second reforming reaction zone. Thus, the feed conduit may be a tube extending within the reformer tube, e.g. along or parallel to the longitudinal axis thereof, from one of the ends of the reformer tube. As used herein, the reformer tube is seen as a tube extending from a first end along a longitudinal axis to a second end. Alternatively, a feed conduit having inlets into the second reforming reaction zone may extend within the reformer tube from the first to the second end thereof.

In an embodiment, the second part of the feed conduit comprises second inlet(s) at one or more points along the longitudinal axis of the reformer tube and/or a frit material extending along at least a part of the longitudinal axis for letting the second feed stream into the second reforming reaction zone along at least a part of the longitudinal axis of the reformer tube housing the feed conduit. Thus, the second feed stream may be inlet, via one or more inlets, at a single distance along the longitudinal axis of the reformer tube, or via more than one inlet at different distances along the longitudinal axis. Additionally, or alternatively, the second part comprises a frit material allowing the second feed stream to pass through the frit material over a certain extent along the longitudinal axis. Throughout this text, the term “frit material” is meant to denote a porous material or a material with a plurality of holes through which a gas or liquid may pass. By use of a frit material instead of one or more inlets, the second feed stream may be added into the second reforming reaction zone over a larger area thereof.

In an embodiment, the electrically driven heat source is arranged to heat the catalyst material within the reformer tube to a maximum temperature of at least 750° C. Typically, the first feed stream is preheated to an inlet temperature prior to entering the reformer tube of between about 400° C. and 650° C. and a temperature before exiting the reformer tube of above 800° C., above 850° C. or even at or above 900° C. Moreover, the temperature of the catalyst material within the reformer tube at the point(s) of inletting the second feed stream into the second reforming reaction zone is e.g. above 750° C., e.g. at about 800° C., or at about 850° C. or at about 900° C.

In an embodiment, the electrically driven heat source comprises an induction coil and a power source arranged to supply alternating current, and the induction coil is arranged to be powered by the power source. The induction coil is positioned so as to generate an alternating magnetic field within the reformer tube upon energization by the power source, and the reformer tube houses a ferromagnetic material which is ferromagnetic at least at temperatures up to an upper limit of a given temperature range T. Hereby, the reformer tube and thus the catalyst material is heated by the heating of the ferromagnetic material. The catalyst material itself may be ferromagnetic, e.g. in the form of catalytically active material supported on a ferromagnetic support, or the ferromagnetic material may be elements positioned within the reformer tube together with the catalyst material; such elements could be pellets, balls, rods, discs or other elements of appropriate size and shape in order to provide appropriate heating to the catalyst material within the reformer tube.

In another embodiment, the electrically driven heat source comprises electrically conductive material housed within the reformer tube and an electrical power source connected to the electrically conductive material, in order to allow an electrical current to run through the electrically conductive material during operation of the chemical reactor. Hereby, heat is generated within the electrically conductive material and the heat is given off by the electrically conductive material to the catalyst material. By supplying a current through the electrical conductive material within the reformer tube, it is heated by resistance or ohmic heating and dissipates heat to the catalyst material/reformer tube. The skilled person knows how to choose an electrically conductive material with appropriate resistivity and/or shape in order to achieve the required heat transmission to the catalyst material.

The catalyst material itself may be electrically conductive, e.g. in the form of catalytically active material supported on an electrically conductive support, e.g. in the form of one or more electrically conductive monoliths. In this case, it is an advantage if the catalyst material comprises one or only a few monoliths of catalyst material or of electrically conductive material supporting catalyst material, in order to ease an electrical connection through the electrically conductive material.

Alternatively, the electrically conductive material could be elements positioned within the reformer tube together with the catalyst material; such elements could be rods, discs or other elements of appropriate size and shape in order to provide appropriate heating to the catalyst material within the reformer tube.

In an embodiment, the feed conduit is arranged to withstand temperatures at least up to 850° C. Typically, the pressure difference over the wall of the feed conduit is low, e.g. less than 1-2 bar, so that the materials which are able to withstand such temperatures and advantageously also conduct heat well will be suitable candidates.

In an embodiment, the chemical reactor further comprises heat exchange means for heating the second feed stream to a temperature of at least 700° C. Advantageously, the heat exchange means are arranged to heat the second feed stream to a temperature of about 750° C. prior to addition to the second reforming reaction zone. Such heat exchange means may comprise a separate heat exchanger arranged to heat the second feed stream upstream of the feed conduit and/or an arrangement within the chemical reactor so that heat is exchanged between the feed conduit and the first reforming reaction zone upstream the second reforming reaction zone.

In all embodiments, the reformer tube may also comprise thermal insulation, at least partly surrounding the catalyst material, in order to minimize heat loss to the surroundings.

According to another aspect, the invention relates to a process of reforming a first feed stream in a chemical reactor. The process comprises the steps of:

a) electrically heating catalyst material within a reformer tube of the chemical reactor, by means of an electrically driven heat source
b) inletting the first feed stream into a first inlet into a first reforming reaction zone of the reformer tube,
c) carrying out reforming reaction of the first feed stream within the first reforming reaction zone,
d) inletting a second feed stream into a feed conduit, wherein the feed conduit is configured so that the second feed stream is only in contact with catalyst material in the second reforming reaction zone,
e) conducting the second feed stream in heat exchanges contact with catalyst material housed within the reformer tube and inletting the second feed stream into a second reforming reaction zone into the reformer tube, and
f) carrying out reforming reaction of the first feed stream and the second feed stream within the second reforming reaction zone,
wherein the second reforming reaction zone is positioned downstream of the first reforming reaction zone, where the second feed stream comprises at least 50 dry mole % CO₂ and where the second feed stream is heated prior to introduction thereof into the second reforming reaction zone of the reformer tube. The catalyst material may be heated by resistance heating, e.g. by electrical conduction through the reformer tube, by electrical conduction through the catalyst material, by electrical conduction through electrically conductive elements placed within the reformer tube and arranged to give off heat to surrounding catalyst material, or by a combination thereof. The catalyst material may additionally or alternatively be heated by induction heating in the case where the catalyst material is ferromagnetic or is supported on ferromagnetic material and/or if ferromagnetic elements are housed in the reformer tube together with catalyst material.

By the process the second feed stream is added into the chemical reactor at a position where the first feed stream comprising a hydrocarbon gas and steam has already been at least partly reformed. This partly reformed first feed stream is thus mixed with the second feed stream. This mixing allows the elemental H/C and O/C ratios of the gas within the second reforming reaction zone to differ from the H/C and O/C ratios within the first reforming reaction zone. The composition of the second feed stream thus renders it possible to change the H/C and O/C ratios of the gas to a gas which would be considered critical with respect to carbon formation in a typical steam reformer configuration, without being critical in the concept of the invention.

Within this context, the term S/C or “S/C ratio” is an abbreviation for the steam-to-carbon ratio. The steam-to-carbon ratio is the ratio of moles of steam to moles of carbon in hydrocarbons in a gas. Thus, S/C is the total number of moles of steam added divided by the total number of moles of carbon from the hydrocarbons in the gas. Moreover, the term “O/C” or “O/C ratio” is an abbreviation for the atomic oxygen-to-carbon ratio. The oxygen-to-carbon ratio is the ratio of moles of oxygen to moles of carbon in a gas. Furthermore, the term H/C or “H/C ratio” is an abbreviation for the atomic hydrogen-to-carbon ratio. The hydrogen-to-carbon ratio is the ratio of moles hydrogen to moles of carbon in a gas. It should be noted that the term “C” in the ratio S/C thus is different from the “C” in the ratios H/C and O/C, since in S/C “C” is from hydrocarbons only, whilst in O/C and H/C, “C” denotes all the carbon in the gas.

By heating the second feed prior to introduction thereof into the second reforming reaction zone of the reformer tube, operating conditions with risk of carbon formation can be avoided and a synthesis gas can be produced at more critical conditions than typical reforming. For example, the second feed stream is heated to about 800° C. prior to being added into the second reforming reaction zone.

When the second feed stream is a CO₂ rich gas, a CO rich synthesis gas is produced by the process of the invention, whilst alleviating problems of carbon formation on the catalyst material. Within this text the term “a CO₂ rich gas” is meant to denote a gas comprising at least 50 dry mole % CO₂, such as at least 70 dry mole % CO₂, such as at least 90 dry mole % CO₂.

Typically, the catalyst material within the reformer tube is a reforming catalyst. Advantageously, the catalyst material is arranged to catalyze steam methane reforming (reactions (i), (ii) and optionally (iv)), dry methane reforming (reaction iii) and water gas shift reactions (reaction (v)). Typically, the first and the second reforming reaction zones contain the same type of catalyst material.

Examples of reforming catalysts are Ni/MgAl₂O₄, Ni/Al₂O₃, Ni/CaAl₂O₄, Ru/MgAl₂O₄, Rh/MgAl₂O₄, Ir/MgAl₂O₄, Mo₂C, Wo₂C, CeO₂, a noble metal on an Al₂O₃ carrier, but other catalysts suitable for reforming are also conceivable. The terms “reforming catalysts” and “steam reforming catalysts” are meant to be synonymous. Moreover, it is possible to have a configuration with different types of catalyst materials (e.g. the ones mentioned above) in the first and second reforming reaction zone and/or different types of catalyst material in the addition zone and the third reforming reaction zone. Thus, as an example only, the first and third reforming reaction could contain one type of catalyst material, whilst the addition zone contains a different type of catalyst material.

The catalytic activity for reforming reactions in the chemical reactor can be obtained either by conventional fixed beds of (pellet) catalysts, by catalysed hardware, or by structured catalysts. Catalytically active material may be added directly to a metal surface, viz. the surface of the support. The catalytic coating of a metal surface (wash coating) is a well-known process (a description is given in e.g. Cybulski, A., and Moulijn, J. A., Structured catalysts and reactors, Marcel Dekker, Inc, New York, 1998, Chapter 3, and references herein).

The appropriate material of the macroscopic support, e.g. a ferritic steel containing Cr and/or Al, is heated to a temperature preferably above 800° C. in order to form a layer of Cr and/or Al oxide. This layer facilitates a good adhesion of the ceramic to the steel. A thin layer of a slurry containing the ceramic precursor is applied on the surface by means of e.g. spraying, painting or dipping. After applying the coat, the slurry is dried and calcined at a temperature usually in the region 350-1000° C. Finally, the ceramic layer is impregnated with the catalytically active material, e.g. catalytically active particles. Alternatively, the catalytically active material is applied simultaneously with the ceramic precursor.

Catalysed hardware either be catalytically active material attached directly to a channel wall in which the process gas flows or catalytically active material attached to a metallic macroscopic support in the form of a structured element. The structured element serves to provide support to the catalytically active material.

Structured elements are devices comprising a plurality of layers with flow channels present between the adjoining layers. The layers are shaped in such a way that placing the adjoining layers together results in an element in which the flow channels can, for instance, cross each other or can form straight channels. Structured elements are further described in for instance U.S. Pat. Nos. 5,536,699, 4,985,230, EP396,650, EP433,223 and EP208,929.

The structured elements are e.g. straight-channelled elements or the cross-corrugated elements. For example, straight channel monoliths are suitable for use in the process of the invention in adiabatic post converter(s). Cross-corrugated elements allow efficient heat transfer from the reactor wall to the gas stream. Other catalysed structured elements can also be applied, such as high surface structured elements. Examples of structured catalysts includes catalysed monoliths, catalysed cross-corrugated structures and catalysed rings (e.g pall-rings).

The amount of catalytically active material can be tailored to the required catalytic activity for the methane reforming reactions at the given operating conditions. In this manner the pressure drop is lower and the amount of catalyst is not more than needed which is especially an advantage if the costly noble metals are used.

The electrically driven heat source may be an inductive heat source arranged to heat a ferromagnetic catalyst material and/or other ferromagnetic elements inductively by means of a coil surrounding the ferromagnetic catalyst material and/or other ferromagnetic elements, and powering the coil with an alternating electrical field. Alternatively, the electrically driven heat source may be an electrical power source arranged to heat electrically conductive catalyst material and/or other electrically conductive elements within the reformer tube by resistance heating or ohmic heating. Combinations of inductive and resistance heating are also conceivable. In the invention, the electrically driven heat source of the chemical reactor may be solely electrically driven, so that no other heat sources are present; alternatively, other heat sources, such as e.g. a convective heat exchanger, may be used in addition to the electrically driven heat source

In an embodiment, step e) of the method comprises leading the second feed stream into the second reforming reaction zone within a first part of the feed conduit arranged for conducting the second feed stream along the first reforming reaction zone, and inletting the second feed stream into the reformer tube via the second inlet in a second part of the feed conduit. Typically, the second feed stream within the feed conduit is heated by heat exchange between the feed conduit and the first reforming reaction zone upstream the second reforming reaction zone, prior to being inlet into the second reforming reaction zone. The feed conduit may alternatively or additionally be configured for heating the second feed stream by heat exchange between the second feed stream and the second reforming reaction zone.

In an embodiment, the second feed stream is conducted along the longitudinal axis of the reformer tube from a first and/or a second end of the reformer tube to the second reforming reaction zone. When the second feed stream is conducted in heat exchange contact with some of the second reforming reaction zone and optionally also the third reforming reaction zone prior to being inlet into the second reforming reaction zone, the temperature of the second feed stream is increased. The heat exchange may increase the temperature of the second feed stream to a higher temperature than the catalyst material within the first reforming reaction zone; this reduces the risk of carbon formation in the addition point of the second feed stream to the second reforming reaction zone and improves the overall operation of the chemical reactor. For example, the feed conduit may extend along most of or substantially all of the length of the reformer tube, and the second feed stream may thus be in heat exchange with the most of or substantially all of the length of the second reforming reaction zone.

In an embodiment, the second feed stream is conducted in heat exchange contact with at least a part of a longitudinal extent of the second reforming reaction zone. Thus, the feed conduit may be a tube extending within the reformer tube, along the longitudinal axis thereof, from one of the ends of the reformer tube. Alternatively, a feed conduit having inlets into the second reforming reaction zone may extend within the reformer tube from the first to the second end thereof.

In an embodiment, the step of inletting a second feed steam comprises inletting the second feed stream into the second reforming reaction zone at one or more points along a longitudinal axis of the reformer tube and/or into a frit material extending along at least a part of the longitudinal axis for letting the second feed stream into said second reforming reaction zone along at least a part of the longitudinal axis of the reformer tube housing the feed conduit. Thus, the second feed stream may be inlet, via one or more inlets, at a single distance along the longitudinal axis of the reformer tube, or via more than one inlet at different distances along the longitudinal axis. Additionally, or alternatively, the second part comprises a frit material allowing the second feed stream to pass through the frit material over a certain extent along the longitudinal axis. By use of a frit material instead of one or more inlets, the second feed stream may be added into the second reforming reaction zone over a larger area thereof.

In an embodiment, the second feed stream comprises: at least 90 dry mole % CO₂. The second feed stream may be substantially pure CO₂.

In an embodiment, the second feed stream further comprises one or more of the following constituents: steam, hydrogen, carbon monoxide, hydrogen sulfide, sulfur dioxide, nitrogen, argon. Additionally, the second feed stream could contain smaller amounts of methane. Such a second feed stream could for example be a recycle gas stream from a reducing gas process.

In an embodiment, the mole fraction between CO₂ in the second feed stream and hydrocarbons in the first feed stream is larger than 0.5. A ratio between CO₂ in the second feed stream and hydrocarbons in the first feed stream may e.g. be about 1:1; about 2:1, about 3:1, about 4:1, about 5:1, about 6:1 or even higher.

In an embodiment, the first feed stream further comprises one or more of the following constituents: hydrogen, carbon monoxide, carbon dioxide, nitrogen, argon, higher hydrocarbons, or mixtures thereof.

In an embodiment, the steam-to-carbon ratio in the first feed stream is between about 0.7 and about 2.0. In the case where all hydrocarbons in the gas are in the form of CH₄, the steam to carbon ratio S/C would correspond to the ratio between H₂O and CH₄. In the case where the gas also comprises higher hydrocarbons, the S/C ratio will be lower than the H₂O/CH₄ ratio.

In an embodiment, the electrically driven heat source is arranged to heat the catalyst material within the reformer tube to temperatures of between about 650° C. and about 950° C. It should be understood, that not all the catalyst material within the chemical reactor needs to be heated to a temperature between 650° C. and about 950° C.; instead at least some of the catalyst material is heated to a temperature between 650° C. and about 950° C. Thus, in a part of the chemical reactor close to the inlet, the catalyst material may be heated to a temperature of e.g. 450° C. or 500° C.; and in a part of the chemical reactor close to the outlet, the catalyst material may be heated to a temperature of more than 950° C., such as e.g. 1000° C. The first synthesis gas exiting the chemical reactor has a temperature of up to 950° C. Typically, the pressure within the reformer tube is above 5 barg and below 35 barg, for example between 25 and 30 barg.

In an embodiment, the second feed stream in step f) is heated to a temperature of between about 700° C. and about 950° C. Hereby, operating conditions with risk of carbon formation can be avoided and a synthesis gas can be produced at more critical conditions than by reforming without addition of heated carbon dioxide.

According to a further aspect, the invention also relates to a plant for reforming of a first feed stream comprising a hydrocarbon gas and steam, the plant comprising a chemical reactor according to the invention. The chemical reactor is arranged to receive a first feed stream and a second feed stream and to output a first synthesis gas. The chemical reactor comprises an addition point for addition of a third feed stream to the first synthesis gas to a mixed gas, and an adiabatic post converter comprising a second catalyst material. The adiabatic post converter is arranged to receive the mixed gas and equilibrating reverse water gas shift, methanation and steam methane reforming reactions for the mixed gas to provide a second synthesis gas having a lower H₂/CO ratio than the first synthesis gas. By the plant of the invention, the CO₂ addition takes place both within the reformer tubes and downstream the chemical reactor. Hereby, the temperature drop within the addition zone of the reformer tubes is reduced and thus the risk of carbon formation is reduced. The second catalyst material may be similar to the catalyst material described in relation to the other aspects of the invention. Alternatively, the second catalyst material may be a selective reverse water gas shift catalyst. As used herein, the term “reverse water gas shift” is meant to denote the opposite reaction of reaction (v), viz.:

CO₂+H₂↔CO+H₂O.

Moreover, the term “adiabatic post converter” is meant to denote an adiabatic reactor downstream a chemical reactor, such as a steam methane reformer, where the steam reforming, methanation and reverse water gas shift reaction run towards equilibrium in the adiabatic post converter. The product gas from the chemical reactor is converted into a product synthesis gas in the adiabatic post converter, the product synthesis gas having a lower H₂/CO ratio than the gas from the chemical reactor.

### BRIEF DESCRIPTION OF THE DRAWINGS

Embodiments of the present invention are explained, by way of example, and with reference to the accompanying drawings. It is to be noted that the appended drawings illustrate only examples of embodiments of this invention and are therefore not to be considered limiting of its scope, for the invention may admit to other equally effective embodiments.

FIGS. 1a to 4b are schematic drawings illustrating cross sections through embodiments of a chemical reactor of the invention;

FIG. 5 is a diagram showing the temperature within a reformer tube of the invention as a function of axial position; and

FIG. 6 is a drawing of a chemical plant with a steam reformer and further CO₂ addition.

### DETAILED DESCRIPTION

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

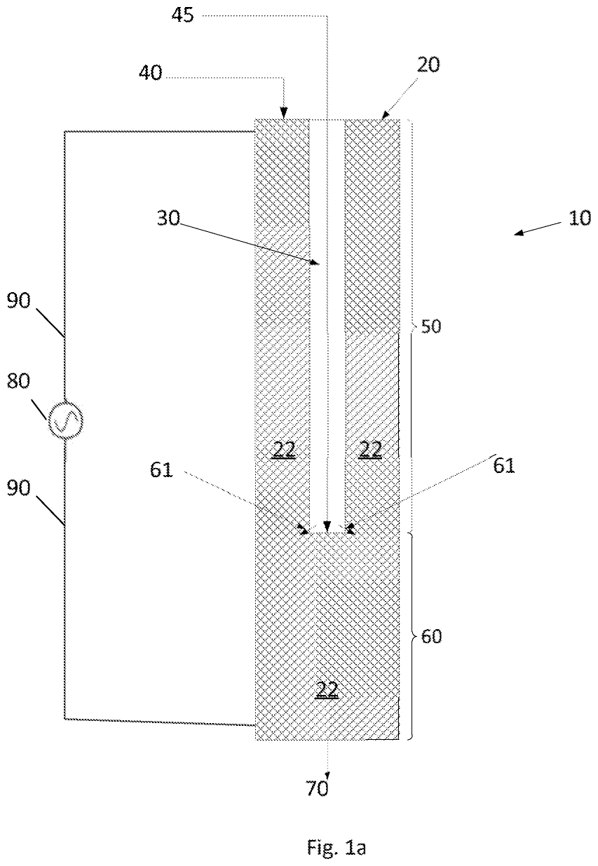

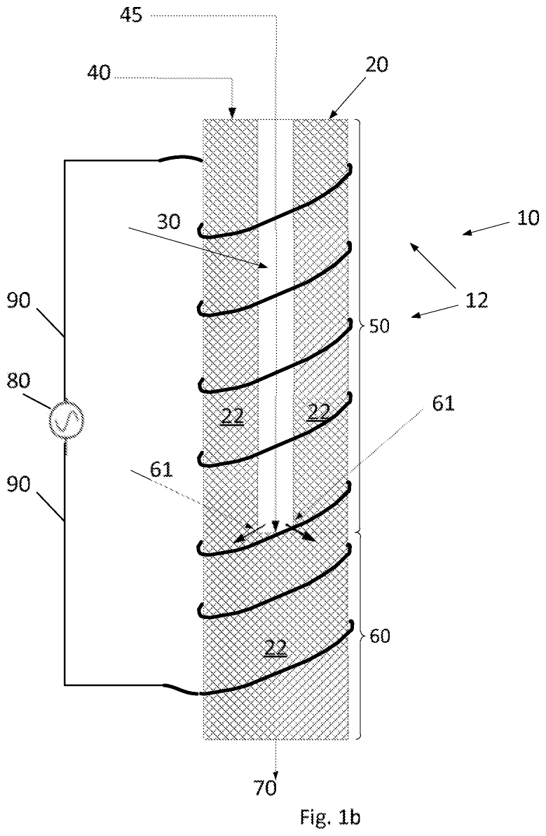

FIG. 1a is a schematic drawing illustrating a cross section through a chemical reactor 10 of the invention for carrying out reforming of a first feed stream comprising a hydrocarbon gas and steam. The chemical reactor 10 of the invention, also denoted “the reformer” or “the steam reformer”, comprises one or more reformer tubes 20 housing electrically conductive catalyst material 22 as shown by hatching. For the sake of simplicity, only a single reformer tube 20 is shown in FIG. 1; however, the reformer may comprise a multitude of such reformer tubes 20. The reformer tube 20 is under operation heated by the electrically driven heat source in the form of an electrical power supply 80 connected to the catalyst material 22 by means of electrical wires 90. The electrically conductive catalyst material may be a monolith for ease of resistive heating thereof. The reformer tube 20 has a first inlet for feeding a first feed stream 40 into a first reforming reaction zone 50 of the reformer tube. The reformer tube 20 moreover comprises a feed conduit 30 arranged to allow a second feed stream 45 to be led in heat exchange contact with the catalyst material 22 in the first reforming reaction zone 50 and to be added into a second reforming reaction zone 60 of the reformer tube 20 at addition points 61, where the second reforming reaction zone 60 is positioned downstream of the first reforming reaction zone 50. In the embodiment shown in FIG. 1, the second reforming reaction zone 60 consists of the addition zone or addition point 61 and the third reforming reaction zone downstream the addition point. Thus, in FIG. 1 the third reforming reaction zone constitutes most of the second reforming reaction zone 60, since the addition zone is constituted by one or more addition points at at least substantially equal distance from the first inlet into the reformer tube 20. The second feed stream 45 is kept separate from the catalyst material 22 until the second reforming reaction zone 60, viz. until the addition points 61. During operation, a first synthesis gas 70, viz. a CO rich synthesis gas 70, exits the reformer tube 20/the steam reformer 10.

FIG. 1b is an embodiment similar to the embodiment shown in FIG. 1a, except from the fact that in the embodiment in FIG. 1b, the catalyst material 22 is inductively heated instead of being heated by ohmic heating or resistance heating. To this end, the electrically driven heat source of the embodiment of FIG. 1b comprises a plurality of coils 12 wound around the catalyst material 22 and connected to an electrical power source 80 via electrical wires 90. Alternatively, the coils could be would around the individual reformer tubes 20.

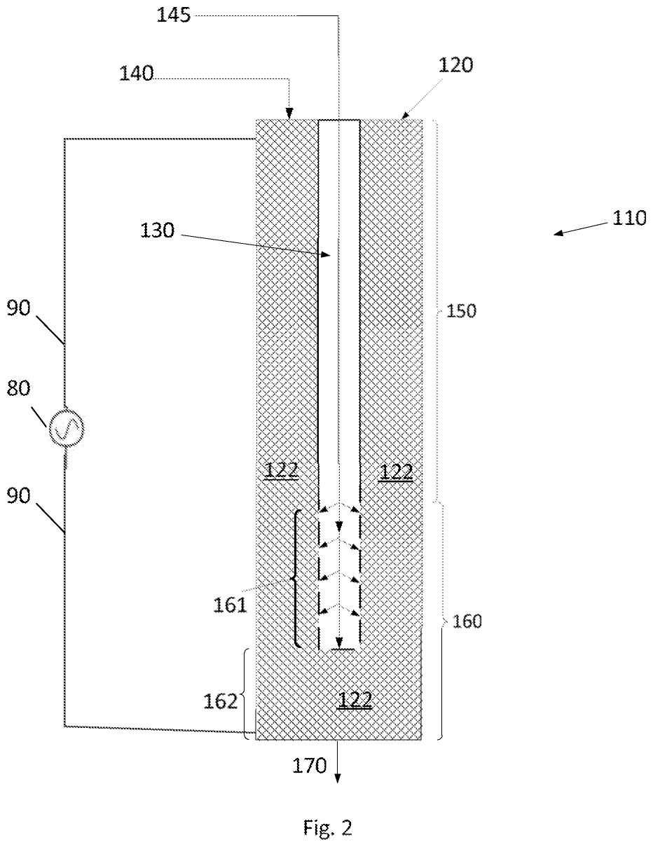

FIG. 2 is a schematic drawing illustrating a cross section through a chemical reactor 110 of the invention for reforming of a first feed stream comprising a hydrocarbon gas and steam.

The chemical reactor 110 of the invention, also denoted “the reformer”, one or more reformer tubes 120 housing electrically conductive catalyst material 122 as shown by hatching. The reformer tube 120 is under operation heated by the electrically driven heat source in the form of an electrical power supply 80 connected to the catalyst material 122 by means of electrical wires 90. The electrically conductive catalyst material may be a monolith for ease of resistive heating thereof. The reformer tube 120 has a first inlet for feeding the first feed stream 140 into a first reforming reaction zone 150 of the reformer tube. The reformer tube 120 moreover comprises a feed conduit 130 having a first part extending longitudinally along the first reforming reaction zone 150 and arranged to conduct a second feed stream 145 along the first reforming reaction zone 150 and a second part arranged for inletting the second feed stream 145 into the catalyst material 122 within the second reforming reaction zone 160 of the reformer tube, where the second reforming reaction zone 160 is positioned downstream of the first reforming reaction zone 150 (as seen from both the first and second feed streams). In the embodiment shown in FIG. 2, the second part of the feed conduit 130 extends from the beginning of the second reforming reaction zone 160 to the lower end of the feed conduit 130. The second reforming reaction zone 160 contains an addition zone 161 corresponding to the second part of the feed conduit 130 and a third reforming reaction zone 162 downstream the addition zone 161.

The second part of the feed conduit 130 has a plurality of inlets into the second reforming reaction zone 160 as indicated by arrows from the second part of the feed conduit 130 into the catalyst material 122 of the reformer tube, viz. into the addition zone 161 of second reforming reaction zone 160. The inlets may be a plurality of individual inlets from the feed conduit 130 into the addition zone of the second reforming reaction zone 160, or the inlets may be formed by choosing a frit material for the lowermost part of the feed conduit (as seen in FIG. 2) which lets the second feed stream 145 into the addition zone 161 of the second reforming reaction zone 160 along at least a part of the longitudinal axis (not shown) of the reformer tube 120. As an alternative (not shown), the feed conduit 130 could be a through tube extending from the upper to the lower end of the reformer tube 120, where only a part thereof has inlets into the reformer tube 120. The first synthesis gas 170, viz. the resultant CO rich synthesis gas 170, exits the reformer tube 120/the reformer 110.

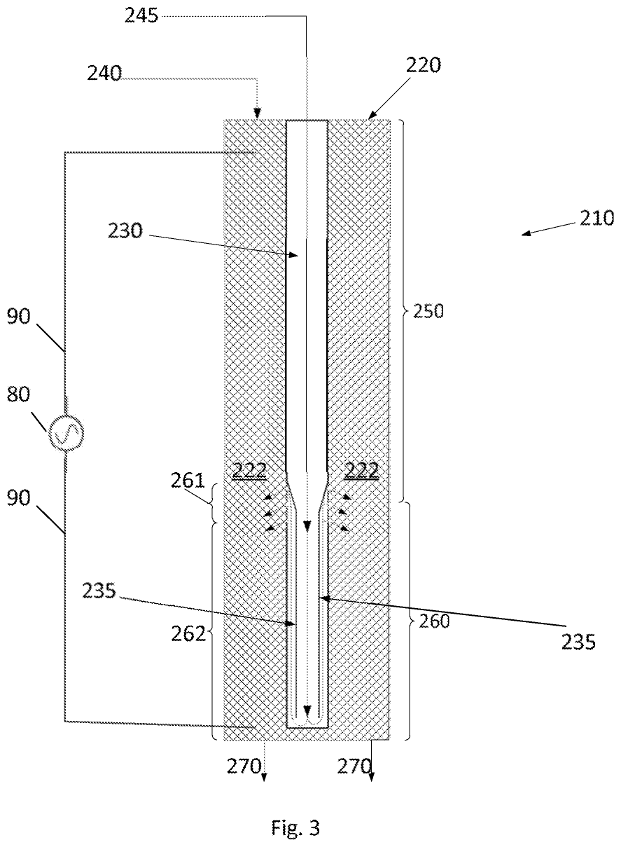

FIG. 3 is a schematic drawing illustrating an alternative chemical reactor 210 of the invention. The chemical reactor 210 is a reformer tube reactor having one or more reformer tubes 220; in FIG. 3 only one such reformer tube 220 is shown. Under operation, the reformer tube 220 is heated by one or more electrically driven heat sources in the form of an electrical power supply 80 connected to the catalyst material 22 by means of electrical wires 90. The electrically conductive catalyst material may be a monolith for ease of resistive heating thereof. The reformer tube 220 has a first inlet for feeding a first feed stream 240 into a first reforming reaction zone 250 of the reformer tube 220. A second reforming reaction zone 260 extends from the lower part of the first reforming reaction zone 250 (as seen in FIG. 3) to the lower end of the reformer tube 220.

The reformer tube 220 moreover comprises a feed conduit 230 extending along a longitudinal axis (not shown in FIG. 3) of the reformer tube 220, in most of the length of the reformer tube 220. The part of the reformer tube 220 not taken up by the feed conduit 230 is shown as filled with catalyst material 222. Thus, the feed conduit 230 extends into the second reforming reaction zone 260. The feed conduit 230 comprises a baffle 235 arranged to conduct the second feed stream 245 in heat exchange contact with most of the second reforming reaction zone 260 prior to allowing the second feed stream 245 into an addition zone 261 of the second reforming reaction zone 260 via the second part of the feed conduit 230. This is illustrated by the arrows indicating the flow of the second feed stream 245 along the length of the feed conduit 230, where the second feed stream 245 at the bottom of the feed conduit 230 is redirected upwards along the inner wall of the feed conduit 230, between the feed conduit and the baffle 235.

The feed conduit 230 has a plurality of inlets into the addition zone 261 of the second reforming reaction zone 260 as indicated by arrows from the second part of the feed conduit 230 into the catalyst material 222 of the reformer tube. The inlets may be a plurality of individual inlets from the feed conduit 230 into the second reforming reaction zone 260, or the inlets may be formed by choosing a frit material for this second part of the feed conduit 230.

The second reforming reaction zone 260 of the reformer tube 220 thus contains an addition zone 261 and a third reforming reaction zone 262. Again, in the first reforming reaction zone 250, reforming of the first feed stream takes place as well as heat exchange between the first reforming reaction zone and the feed conduit. In the addition zone 261 of the second reforming reaction zone 260, the second feed stream 245 is added into the catalyst housing second reforming reaction zone 260. Here the second feed stream 245 is mixed with the partially reformed first feed stream 240. In the third reforming reaction zone, no further second feed stream is added. Here, reforming of the first and second feed streams takes place as well as heat exchange between the second feed stream 245 within the conduct and the catalyst material in the third reforming reaction zone of the reformer tube 220. Thus, the second feed stream 245 experiences heat exchange both in the first reforming reaction zone 250, in the addition zone 261 of the second reforming reaction zone 260 and in at least a part of, if not all of, the third reforming reaction zone 262. The first synthesis gas 270, viz. the resultant CO rich synthesis gas 270, exits the reformer tube 220/the reformer 210.

It should be noted, that even though FIG. 3 shows an embodiment where the feed conduit 230 does not extend in the whole length of the reformer tube 220, it is conceivable that the feed conduit 230 extends in the whole length of the reformer tube 220 or even protrudes through the lower end of the reformer tube 220 (as seen in FIG. 3). Such configurations would provide for further heating of the second feed stream 245.

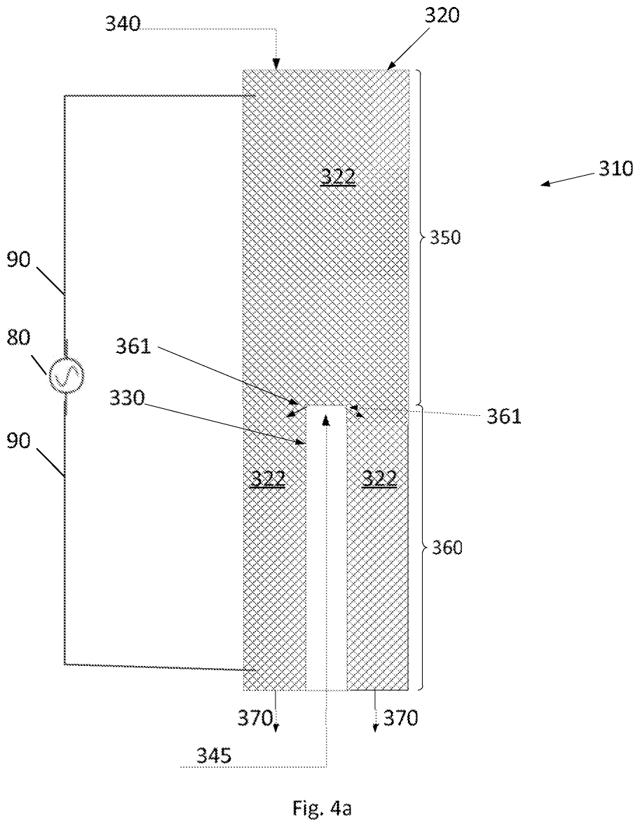

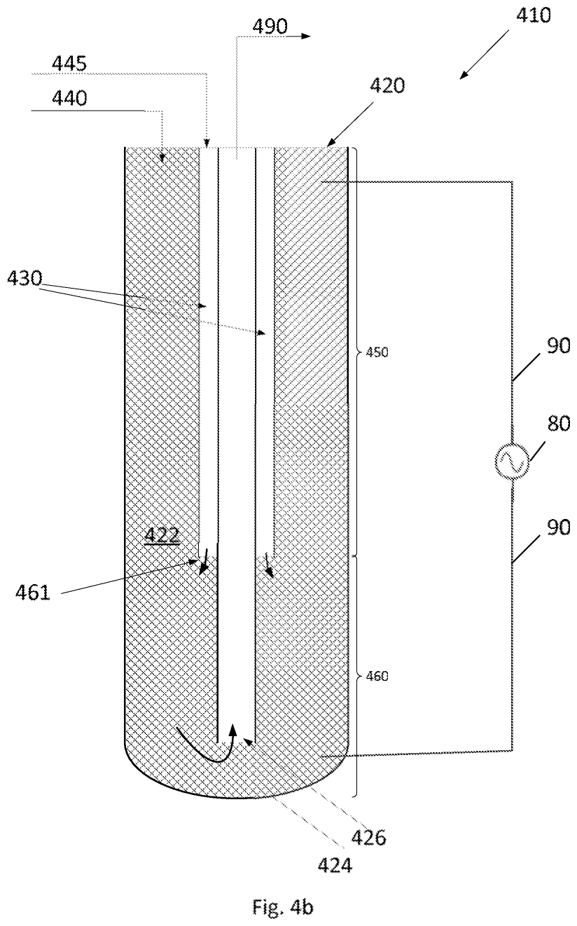

FIG. 4a is a schematic drawing illustrating a cross section through a chemical reactor 310 of the invention for reforming of a first feed stream comprising a hydrocarbon gas and steam. The chemical reactor 310 of the invention, also denoted “the reformer”, comprises one or more reformer tubes 220 comprising electrically conductive catalyst material 322 as indicated by hatching. The reformer tube 320 is under operation heated by a heat source in the form of an electrical power supply 80 connected to the electrically conductive catalyst material 322 by means of electrical wires 90. The electrically conductive catalyst material 322 may be a monolith for ease of resistive heating thereof. The reformer tube 320 has a first inlet for feeding a first feed stream 340 into a first reforming reaction zone 350 of the reformer tube. The reformer tube 320 moreover comprises a feed conduit 330 arranged to allow a second feed stream 345 into a second reforming reaction zone 360 of the reformer tube 320, where the second reforming reaction zone 360 is positioned downstream of the first reforming reaction zone 350 (as seen from the flow direction of the first feed stream).

In the reformer 310 shown in FIG. 4a, the first feed stream 340 is inlet into the reformer tube 320 at a first, upper end thereof, whilst the feed conduit extends within the reformer tube from a second, lower end of the reformer tube 320. Also in this embodiment, the first reforming reaction zone extends from the upper end of the reformer tube 320, viz. from the inlet of the first feed stream, to the second reforming reaction zone 360. The second reforming reaction zone 360 extends from the most upstream (as seen in the flow direction of the first feed stream) addition point(s) 361 of the second feed stream 345 until the lower end of the reformer tube 320. The second reforming reaction zone 360 consists of the addition zone or the addition points 361 and the third reforming reaction zone downstream the addition points 361. Thus, in FIG. 1 the third reforming reaction zone constitutes most of the second reforming reaction zone 360, since the addition zone is constituted by the one or more addition points 361 at at least substantially equal distance from the first inlet into the reformer tube 320. The first synthesis gas 370, viz. the CO rich synthesis gas 370, exits the reformer tube 320/the reformer 310.

FIG. 4b is a schematic drawing illustrating an alternative reformer tube of the invention. FIG. 4b shows in a simplified form a cross section through a bayonet tube reactor 410 according to the invention. The bayonet tube reactor 410 has one or more reformer tubes 420; in FIG. 4b only one such reformer tube 420 is shown. The reformer tubes 420 are under operation heated by an electrically driven heat source. The reformer tube 420 comprises an outer tube 424, that is open at an inlet for inletting a first feed stream 440 in the upper end thereof (as seen in FIG. 4b), viz. into the first reforming reaction zone 450 of the reformer tube 420. The reformer tube 420 is closed in the lower end thereof (as seen in FIG. 4b). The first feed stream 440 typically comprises a hydrocarbon gas and steam. Within the outer tube 424 an inner tube 426 is located and fixed, coaxially spaced apart from the outer tube 424. The inner tube 426 is open at both its lower and upper end. The reformer tube 420 moreover comprises a feed conduit 430 coaxially spaced from both the outer and inner tubes and placed between the outer and inner tubes 424, 426. The feed conduit 430 extends coaxially along a part of the inner tube 426 along the longitudinal axis (not shown in FIG. 4b) of the reformer tube 420. The feed conduit 430 has inlet for allowing a second feed stream 445 into a second reforming reaction zone 460 of the reformer tube 420. Catalyst 422 is provided within the outer tube 424, but not within the feed conduit 430 or the inner tube 426. The catalyst 422 is shown by hatching in FIG. 4b.

In the chemical reactor shown in FIG. 4b, the feed conduit 430 has inlets into catalyst within the outer tube 440, as shown by the arrows in the lower end of the feed conduit. However, the feed conduit could have a plurality of inlets along the longitudinal axis of the reformer tube 420 or the lower part of the feed conduit 430 could be made of a frit material allowing the second feed stream 445 to be inlet gradually into the second reforming reaction zone 460, that is along at least a part of the longitudinal axis of the reformer tube 420.

A first feed stream 440 comprising a hydrocarbon gas and steam is fed into the reformer tube 420, viz. the first reforming reaction zone 450, via one or more inlets in the upper end of the reformer tube 420. The first feed stream or process gas is subsequently passed through catalyst 422 arranged between the walls of the outer tube 424 and the feed conduit 430. Having passed through the first reforming reaction zone 450, the process gas is mixed, in an addition zone of the second reforming reaction zone 460, with the second feed stream 445. The mixed gasses are passed through catalyst 422 between the walls of the outer tube 424 and the inner tube 426 in the third reforming reaction zone (not shown in FIG. 4b) within the second reforming reaction zone 460. Subsequently, the gas continues downwards (as seen in FIG. 4b) until it impinges on the lower end of the outer tube 424, where it reverses its direction and continues into the inner tube 426, through which the gas stream is withdrawn as a first synthesis gas 490. Heat exchange takes place between the process gas within the first reforming reaction zone 450 and the second feed stream 445 within the feed conduit 430, between the process gas in the second reforming reaction zone 460 and the first synthesis gas 490 in the inner tube 426 as well as between the second feed stream 445 within the feed conduit and the first synthesis gas 490 in the inner tube 426.

It should be understood that FIGS. 1 to 4b are schematic drawings only illustrating the relevant part of the chemical reactor 10, 110, 210, 310 and 410 of the invention Moreover, FIGS. 1 to 4b do not show the relevant inlets for providing the first feed stream and the second feed stream into the reformer tube 20, 120, 220, a 320 and 420 or an outlet for outletting a first synthesis gas stream from the reformer tube 20, 120, 220, 320 and 420 and from the chemical reactor 10, 110, 210, 310 and 410. In the FIGS. 1 to 4b, the chemical reactors 10, 110, 210 310 and 410 are shown as having only a single reformer tube for simplicity. However, the chemical reactor may comprise a plurality of reformer tubes. Finally, the catalyst material may be surrounded by thermally insulating material in order to prevent heat dissipation to the surroundings; such thermally insulating material is not shown in the figures.

In FIGS. 1 to 4b, the part of the reformer tubes not taken up by the feed conduit is shown as filled with catalyst material. It should be noted that catalyst might not fill up all the available space within the reformer tube in that inert material may be present, e.g. on top of the catalyst material, in between the reforming reaction zones, and/or the topmost part of the reformer tube may be left empty.

It should also be noted that in the embodiments shown in FIGS. 1 and 4 it is indicated that the second feed stream is inlet into the second reforming reaction zone at a single addition point 61, 361 and 461 along the longitudinal direction of the reformer tube 20, 320, 420. In these cases, the third reforming reaction zone can be seen as substantially corresponding to the second reforming reaction zone, since the addition zone of the second reforming reaction zone has no substantial extent in the longitudinal direction of the reformer tube 20, 320, 420.

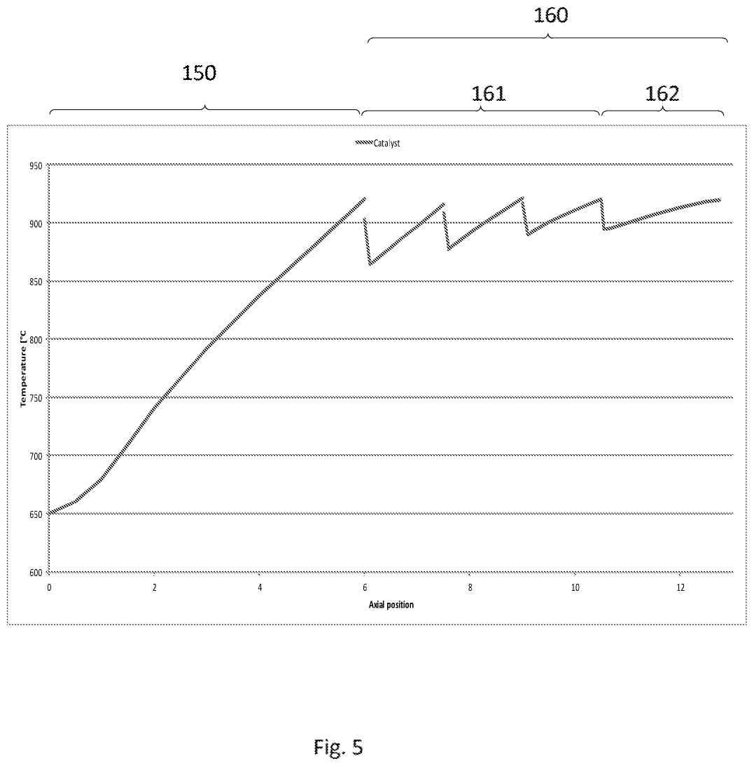

FIG. 5 is a diagram showing the temperature within a reformer tube of the invention as a function of axial position. The reformer tube used has a length of 13 meter, and it could e.g. be a reformer tube 120 as shown in FIG. 2. An axial position of 0 meter corresponds to the inlet into the reformer tube and an axial position of 13 meter corresponds to the outlet of the reformer tube. The reformer tube is heated as described in relation to in FIG. 2. Within the first meter of the reformer tube, the temperature rises from about 650° C. to about 785° C. A feed stream reaches catalyst material within the reformer tube after the inlet, viz. at an axial position of about 0 meter. Typically, the feed stream has a temperature of 450-650° C., when it enters the reformer tube, such as e.g. about 650° C. The first reforming reaction zone 150, where the inlet feed stream reacts with reforming catalyst material within the reformer tube corresponds to axial positions between about 0 meter and about 6 meters.

The second feed stream, typically a CO₂ rich feed stream, e.g. pure CO₂, is inlet into the catalyst material of the reformer tube at four different axial positions, i.e. four different points along the longitudinal axis of the reformer tube. In FIG. 5, the four different, axial positions are at about 6 meters, about 7.5 meters, about 9 meters and about 10.5 meters. The second reforming reaction zone 160 thus ranges from about 6 meters to the outlet of the reformer tube at an axial position of about 13 meter. Within the second reforming reaction zone 160, the addition zone 161 ranges from the first to the last inlet, viz. from about 6 meters to about 10.5 m, and the third reforming reaction zone 162 ranges from the end of the second reforming reaction zone to the end of the reformer tube, viz. from about 10.5 m to about 13 meter. A final conversion and heating of the process gas takes place in the third reforming reaction zone 162.

Because of the endothermic nature of the reverse water gas shift reaction and its fast reaction rate, a very rapid temperature drop follows addition points of CO₂ rich feed stream into the second reforming reaction zone. To avoid carbon formation at the points of adding the second feed stream into the second reforming reaction zone housing catalyst material, the temperature of the process gas within the second reforming reaction zone should be sufficiently high in order to avoid a temperature reduction that could lead to carbon formation on the catalyst material. However, when the reformer tube has multiple inlets from the feed conduit into the second reforming reaction zone, the catalyst material and process gas within the reformer tube does not need to be as high as in the case of only inlet(s) at a single longitudinal position along the reformer tube. In the case of four additions points illustrated in FIG. 5, the temperature drops in the addition points are relatively low. Calculations show that the mean approach to equilibrium for the carbon formations reactions is never within 10° C.

The second feed stream is preheated prior to being inlet into the second reforming reaction zone, typically to a temperature of about 850° C.

The H₂/CO ratio of the first synthesis gas can be controlled by adjusting the addition of H₂O and CO₂, where more H₂O will increase the first synthesis gas towards a hydrogen rich gas and more CO₂ will increase the first synthesis gas towards a CO rich gas. However, when producing a synthesis gas with a very low H₂/CO ratio, an accompanied high H₂O/CH₄ will be necessary to balance the severity of the gas to avoid carbon formation on a nickel catalyst. Producing a synthesis gas with a H₂/CO ratio below 1 in a standard steam methane reformer requires a large excess of water to avoid carbon formation. As example, to produce a synthesis gas of H₂/CO=0.7 in a standard steam methane reformer with a nickel catalyst will require a feed composition of H₂O/CH₄=3 and CO₂/CH₄=4.5.

As an example of the current invention, consider a case where a synthesis gas with H₂/CO ratio of 0.7 is wanted. A feed stream 40, 140, 240, 340, 440 in the form of a mixture of steam and methane is fed to the first reforming reaction zone 50, 150, 250, 350, 450 of a reformer tube 20, 120, 220, 320, 420 and the ratio between steam (H₂O) and methane (CH₄) is chosen with respect to the typical carbon limit for Ni catalysts and the desired synthesis gas. The reformer tube 20, 120, 220, 320, 420 contains catalyst material 22, 122, 222, 322, 422, typically a reforming catalyst, in the first and second reforming reaction zones as shown by the hatching in FIGS. 1 to 4b. Such reforming catalyst may be nickel based catalyst; however, practically any catalyst suitable for reforming could be used.

To produce the desired gas, it is e.g. chosen to operate at a H₂O/CH₄ ratio of 1. A CO₂ rich feed (in the current example pure CO₂) is fed to a feed conduit 30, 130, 230, 330, 430 which does not house catalyst material.

Towards the bottom of the first reforming reaction zone 50, 150, 250, 350, 450 the temperature of the gas in the first reforming reaction zone 50, 150, 250, 350, 450 as well as the temperature of the CO₂ rich gas within the feed conduit 30, 130, 230, 330, 430 are both about 850° C. or higher. This temperature is determined on the basis of the actual gas compositions. This point along the longitudinal axis of the reformer tube 20, 120, 220, 320, corresponding to the transition between the first and second reforming reaction zones, is where the partly reformed gas within the first reforming reaction zone is mixed with heated CO₂ rich gas. The addition of the heated CO₂ rich gas into the second reforming reaction zone shifts the operating point corresponding to an unchanged H₂O/CH₄ ratio of 1, but a change in the CO₂/CH₄ ratio to about 2.6 (instead of a CO₂/CH₄ ratio of 0 before the addition of CO₂ rich gas).

Downstream of the addition point of the CO₂ rich gas, viz. in the second reforming reaction zone, the gas is reformed further to achieve sufficient conversion of methane and finally leaves the reformer tube 20, 120, 220, 320, 420 at a temperature of about 950° C. and a H₂/CO ratio of 0.7. In this case the overall process gas has ratios H₂O/CH₄=1 and CO₂/CH₄=2.6. In order to achieve an outlet gas having a H₂/CO ratio of 0.7 with a conventional reformer tube having a nickel based catalyst, the overall process gas would have ratios H₂O/CH₄=3 and CO₂/CH₄=4.5. Consequently, the co-feed of CO₂ and H₂O of the current invention is significantly lower compared to the feed in the nickel based reformer case.

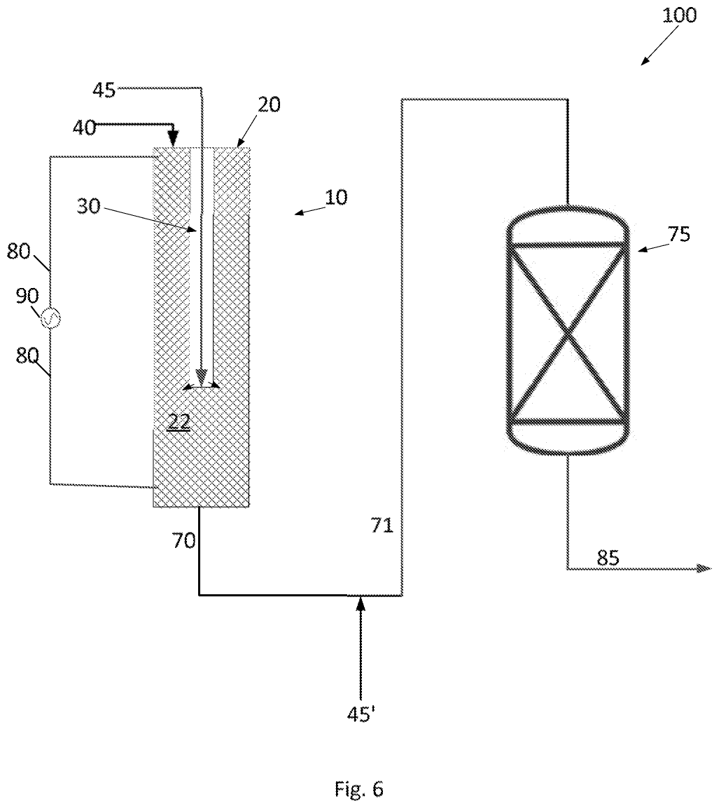

FIG. 6 is a drawing of a plant 100 with a steam reformer 10 according to the invention and further CO₂ addition. To circumvent the drop in temperature in the addition zone of the second reforming reaction zone of the reformer tubes, the CO₂ addition taking place within the reformer tubes is supplemented with a subsequent addition of heated CO₂ rich gas stream 45′ downstream the reforming reactor 10. As seen in FIG. 6, the resulting gas stream 71 is subsequently equilibrated over an adiabatic post converter 75 arranged to facilitate the reverse water gas shift (RWGS) reaction and potentially also the reforming and/or methanation reactions, resulting in a CO rich second synthesis gas 85. The adiabatic post converter 75 comprises a second catalyst material, e.g. catalyst material arranged for both the reverse water gas shift and the steam methane reaction. However, the second catalyst material could also be a selective reverse water gas shift catalyst. From Table 2 below, it can be seen that the H₂/CO ratio of the second synthesis gas 85 from the plant 100 is 30.5/42.1=0.72, which substantially corresponds to the H₂/CO ratio of the synthesis gas stream in Table 1; however, in the plant 100 of FIG. 6, the CO₂ added has been split up, thereby minimizing the risk of carbon formation. It should be noted that the heated CO₂ rich gas stream 45′ added downstream the steam reformer 10 could contain further components than CO₂. Moreover, the concept of splitting the CO₂ addition up could also entail yet further addition(s) of heated CO₂ rich gas stream(s) downstream the adiabatic post converter 75 followed by equilibrating in additional post converter(s). It should also be noted that even though FIG. 6 shows the plant 100 with the chemical reactor 10 of FIG. 1, any of the reactors of the invention could be used in the plant 100.

It should be noted that even though the embodiments shown in FIGS. 2, 3, 4a, 4b and 7 are shown with an electrically driven heat source arranged for resistance heating, other electrically driven heat sources could be used, such as an inductive heat source as described in relation to FIG. 1b or a combination of resistance heating and inductive heating.

### Examples

An example of the process is illustrated in Table 1 below. A first feed stream comprising a hydrocarbon gas and steam and having a S/C ratio of 1 is fed to the first reforming reaction zone of a steam reformer 10 or reformer tube 20 of the invention as shown in FIG. 1. This first feed stream is heated and reformed to a temperature of 850° C., within the first reforming reaction zone. Subsequently, it is mixed with CO₂ which has been heated to 850° C., by heat exchange between the first reforming reaction zone and the feed conduit, while traveling within the feed conduit. Prior to the mixing of the CO₂ and the process gas within the first reforming reaction zone, the H₂/CO ratio is 3.95. Subsequently to the mixing of the process gas within the first reforming reaction zone and the CO₂ from the feed conduit, viz. in the second reforming reaction zone, the mixed process gas is further heated to 950° C. by means of the heaters, while reforming continues to take place. The resulting first synthesis gas has a ratio H₂/CO=0.7 at 950° C.

TABLE 1
Example of process (FIG. 1)

| | |
|---|---|
| Amount of CH₄ First Feed Stream (40) [Nm³/h] | 1000 |
| Amount of H₂O in First Feed Stream (40) [Nm³/h] | 1000 |
| Second Feed Stream (45) CO₂ [Nm³/h] | 2600 |
| P [bar] | 25.5 |
| T_{addition} | 850 |
| H₂/CO prior to CO₂ addition | 3.95 |
| Temp. of second feed stream (CO₂ feed) [° C.] | 850 |
| (45) prior to addition | |
| Tₑₓᵢₜ [° C.] | 950 |
| H₂/CO exit | 0.70 |
| Methane slip exit [dry %] | 0.54 |

Thus, when the chemical reactor, the reformer tube or the process according to the inventions is used, the problems of carbon formation during reforming of a CO₂ rich gas are alleviated. This is due to the fact that the carbon limits are circumvented by adding CO₂ to the hot part of the catalyst material in a reformer tube.

In the Example described above, the second feed stream is a heated stream of pure CO₂. Alternatively, the second feed stream could be a CO₂, H₂O, H₂, CO, O₂, H₂S and/or SO₂. Such a second feed stream could for example be a recycle gas stream from a reducing gas process, as described below.

TABLE 2
Example of process (FIG. 6)

| | Steam | Adiabatic Post |
|---|---|---|
| | reformer 10 | converter 75 |
| Inlet T [° C.] | 650 | 912 |
| Outlet T [° C.] | 950 | 906 |
| Pressure [bar g] | 26 | 25 |
| Outlet MDC T [° C.] | 1159 | 1062 |
| CH₄ feed addition [Nm³/h] | 1000 | — |
| H₂O feed addition [Nm³/h] | 1000 | — |
| CO₂ feed addition [Nm³/h] | 2000* | 600** |
| H₂ out [dry mol %] | 36.9 | 30.5 |
| CO out [dry mol %] | 43.2 | 42.1 |

*The CO₂ is added by a feed conduit as a second feed as e.g. in FIG. 1.
**Second CO₂ rich gas stream is heated to 650° C. before mixing with the gas 70.

### Reducing Gas Process:

As mentioned, the chemical reactor, the reformer tube, and the process of the invention are also suitable for reforming where the second feed stream is a recycle stream from a reducing gas process. Such a recycle stream could arise from a higher alcohol synthesis and would then typically comprise primarily CO₂ and a smaller fraction of H₂S. Alternatively, the recycle stream could arise from the iron reducing processes, such as the one known under the trademark “Midrix”.

As mentioned above, carbon formation in a steam reformer is dictated by thermodynamics and the catalyst material in the steam reformer should not have affinity for carbon formation anywhere in the catalyst material.

In a traditional steam reformer, the input hydrocarbon feed stream would have to be balanced with water in order to circumvent the carbon formation area. Typically, the hydrocarbon feed stream enters a reducing gas reformer at a temperature of between about 500 and about 600° C., while leaving the reducing gas reformer at a temperature of about 950° C., at least not experiencing temperatures above 1000° C. Thus, when designing a reducing gas reformer, there must not be an affinity for carbon formation anywhere between 500-1000° C. The carbon formation is somewhat hindered by the presence of sulfur in the recirculated reducing gas containing sulfur from the metals to be reduced, but the process is limited by carbon formation at low H/C levels and from content of higher hydrocarbons in the feed. Higher hydrocarbons are meant to denote hydrocarbons with more than one carbon atom, such as ethane, ethylene, propane, propylene, etc.

In the reformer reactor, the reformer tube and the process according to the invention as used in connection with a reducing gas plant, the first feed stream comprising a hydrocarbon gas and steam is inlet as into a first reforming reaction zone of the reformer tube. This first reforming reaction zone houses reforming catalyst material, typically nickel based catalyst. The recycle feed stream from the reducing gas plant is fed as a second feed stream into a second reforming reaction zone of the reformer tube, positioned downstream of the first reforming reaction zone. The recycle feed stream from the reducing gas plant may be led within a feed conduit within the first reforming reaction zone so that the recycle feed stream is heated by heat exchange with the catalyst material and process gas within the first reforming reaction zone prior to mixing the thus heated recycle feed stream and process gas at inlets from the feed conduit into the transition area between the first and second reforming reaction zones.

By the process, the steam reformer and reformer tube of the invention, the reforming of the first feed stream comprising a hydrocarbon gas and steam will take place at conditions not leading to carbon formation and the addition of preheated recycled gas from the reducing gas plant will enable production of a low H₂/CO ratio gas.

The present invention describes that steam (water) is added to a hydrocarbon feed stream, typically natural gas, in order to enable steam reforming thereof. In a reducing gas plant, the recycle gas from the metal reduction furnace of the reducing gas plant contains water. Therefore, water should be removed from this recycle gas stream and should be added to the first feed stream prior to the steam reforming of this stream. Some steam may be left in the recycle feed stream, viz. the second feed stream, in order to enable preheating of this stream prior to mixing it with the steam reformed process gas within the first reforming reaction zone of the reformer tube. However, in order to obtain low H₂/CO ratios, it is preferable that the amount of water kept in the recycle feed stream is minimized.

The reducing gas recycle stream typically comprises at least 50 dry mole % CO₂ and one or more of the following constituents: steam, methane, hydrogen, carbon monoxide, hydrogen sulfide, sulfur dioxide, nitrogen, and argon.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the scope of the general inventive concept.

To summarize, the invention relates to a chemical reactor and reformer tubes for reforming a first feed stream comprising a hydrocarbon gas and steam. The chemical reactor comprises one or more reformer tubes arranged to being heated by an electrically driven heat source. The reformer tube comprises a first inlet for feeding the first feed stream into a first reforming reaction zone of the reformer tube, and a feed conduit arranged to allow a second feed stream into a second reforming reaction zone of the reformer tube. The second reforming reaction zone is positioned downstream of the first reforming reaction zone. The invention also relates to a process of producing CO rich synthesis gas at low S/C conditions.

1. A chemical reactor for reforming of a first feed stream comprising a hydrocarbon gas and steam, said chemical reactor comprising:
a reformer tube arranged to house catalyst material, said reformer tube comprising a first inlet for feeding said first feed stream into a first reforming reaction zone of said reformer tube,
where said reformer tube comprises a feed conduit arranged to conduct a second feed stream in heat exchange contact with said catalyst material housed within said reformer tube and allow said second feed stream into a second reforming reaction zone of said reformer tube, said second reforming reaction zone being positioned downstream of said first reforming reaction zone,
wherein said feed conduit is configured so that said second feed stream is in contact with catalyst material in said second reforming reaction zone only, and
an electrically driven heat source arranged to heat the catalyst material within the reformer tube.

2. A chemical reactor according to claim 1, wherein said feed conduit comprises a first part arranged for conducting said second feed stream in heat exchange contact with catalyst material housed within said reformer tube, and a second part arranged for inletting said second feed stream into said second reforming reaction zone of said reformer tube.

3. A chemical reactor according claim 2, wherein said feed conduit extends into said second reforming reaction zone and said feed conduit comprises a baffle arranged to conduct said second feed stream in heat exchange contact with at least a part of said second reforming reaction zone prior to allowing said second feed stream into said second reforming reaction zone via said second part.

4. A chemical reactor according to claim 1, wherein said feed conduit extends within said reformer tube from a first and/or a second end of said reformer tube to said second reforming reaction zone.

5. A chemical reactor according to claim 2, wherein said second part comprises second inlet(s) at one or more points along a longitudinal axis of said reformer tube and/or a frit material extending along at least a part of the longitudinal axis for letting said second feed stream into said second reforming reaction zone along at least a part of the longitudinal axis of said reformer tube housing said feed conduit.

6. A chemical reactor according to claim 1, wherein said electrically driven heat source is arranged to heat the catalyst material within said reformer tube to a maximum temperature of at least 750° C.

7. A chemical reactor according to claim 1, wherein said electrically driven heat source comprises an induction coil and an electrical power source arranged to supply alternating current, where said induction coil is arranged to be powered by said electrical power source, where said induction coil is positioned so as to generate an alternating magnetic field within said reformer tube upon energization by said electrical power source, and wherein said reformer tube houses a ferromagnetic material which is ferromagnetic at least at temperatures up to an upper limit of a given temperature range T.

8. A chemical reactor according to claim 1, wherein said electrically driven heat source comprises electrically conductive material housed within said reformer tube and said electrical power source connected to said electrically conductive material, in order to allow an electrical current to run through said electrically conductive material during operation of said chemical reactor.

9. A chemical reactor according to claim 1, wherein said feed conduit is of a material which is able to withstand temperatures at least up to 850° C.

10. A chemical reactor according to claim 1, further comprising heat exchange means for heating said second feed stream to a temperature of at least 700° C.

11. A process of reforming a first feed stream comprising a hydrocarbon gas and steam in a chemical reactor, said process comprising the steps of:
a) electrically heating catalyst material within a reformer tube of said chemical reactor by means of an electrically driven heat source,
b) inletting said first feed stream into a first inlet into a first reforming reaction zone of said reformer tube,
c) carrying out reforming reaction of said first feed stream within the first reforming reaction zone,
d) inletting a second feed stream into a feed conduit, wherein said feed conduit is configured so that said second feed stream is only in contact with catalyst material in a second reforming reaction zone,
e) conducting said second feed stream in heat exchange contact with catalyst material housed within said reformer tube, and inletting said second feed stream into said second reforming reaction zone into said reformer tube, and
f) carrying out reforming reaction of said first feed stream and said second feed stream within said second reforming reaction zone,
wherein said second reforming reaction zone is positioned downstream of said first reforming reaction zone, where said second feed stream comprises at least 50 dry mole % CO₂ and where said second feed stream is heated prior to introduction thereof into the second reforming reaction zone of said reformer tube.

12. A process according to claim 11, wherein step e) comprises conducting said second feed stream within a first part of said feed conduit arranged for conducting said second feed stream along said first reforming reaction zone, and inletting said second feed stream into said reformer tube via second inlet(s) in a second part of said feed conduit and/or via a frit material extending along at least a part of the longitudinal axis.

13. A process according to claim 12, wherein said second feed stream is conducted from a first and/or a second end of said reformer tube to said second reforming reaction zone.

14. A process according to claim 11, wherein step e) comprises conducting said second feed stream in heat exchange contact with at least a part of a longitudinal extent of said second reforming reaction zone.

15. A process according to claim 11, wherein step e) comprises inletting said second feed stream into said second reforming reaction zone at one or more points along a longitudinal axis of said reformer tube and/or into a frit material extending along at least a part the longitudinal axis for letting said second feed stream into said second reforming reaction zone along at least a part of the longitudinal axis of said reformer tube housing said feed conduit.

16. A process according to claim 11, wherein said second feed stream comprises: at least 90 dry mole % CO₂.

17. A process according to claim 11, wherein the second feed stream further comprises one or more of the following constituents: steam, hydrogen, carbon monoxide, hydrogen sulfide, sulfur dioxide, nitrogen, methane, and argon.

18. A process according to claim 11, wherein the mole fraction between CO₂ in said second feed stream and hydrocarbons in the first feed stream is larger than 0.5.

19. A process according to claim 11, wherein said first feed stream further comprises one or more of the following constituents: hydrogen, carbon monoxide, carbon dioxide, nitrogen, argon, and higher hydrocarbons.

20. A process according to claim 11, wherein the steam-to-carbon ratio in the first feed stream is between about 0.7 and about 2.0.

21. A process according to claim 11, wherein said electrically driven heat source is arranged to heat the catalyst material within said reformer tube to temperatures of between about 650° C. and about 950° C.

22. A process according to claim 11, wherein said second feed stream in step f) is heated to a temperature of between about 700° C. and about 950° C.

23. A plant for reforming of a first feed stream comprising a hydrocarbon gas and steam, said plant comprising a chemical reactor according to claim 1, said chemical reactor being arranged to receive a first feed stream and a second feed stream and to output a first synthesis gas and further comprising:
addition point for addition of a third feed stream to the first synthesis gas to a mixed gas, and
an adiabatic post converter comprising a second catalyst material, said adiabatic post converter being arranged to receive the mixed gas and equilibrating reverse water gas shift reaction for the mixed gas to provide a second synthesis gas having a lower H₂/CO ratio than the first synthesis gas.
